(19) United States
(12) Patent Application Publication
(10) Pub. No.: US 2016/0275206 A1
(43) Pub. Date: Sep. 22, 2016

(54) GEODESIC SKETCHING ON CURVED SURFACES

(71) Applicant: SIEMENS PRODUCT LIFECYCLE MANAGEMENT SOFTWARE INC., Plano, TX (US)

(72) Inventors: Feng Yu, Irvine, CA (US); Derek England, Corona, CA (US); Eric Mawby, Northfield, MN (US); Yong Feng (Fred) Zhao, Zhuji Zhejiang (CN); Haipeng Mao, Shanghai (CN)

(73) Assignee: GEODESIC SKETCHING ON CURVED SURFACES, Plano, TX (US)

(21) Appl. No.: 14/435,413

(22) PCT Filed: May 13, 2014
(86) PCT No.: PCT/CN2014/077337

§ 371 Date: Apr. 13, 2015

(51) Int. Cl. G06F 17/50

(52) U.S. Cl. CPC G06F 17/50

(57) ABSTRACT

Methods for performing geodesic edits and corresponding systems and computer-readable mediums. A method includes receiving a CAD model including at least a three-dimensional (3D) surface. The method includes receiving an edit of a first geodesic feature from a user and in response to the edit, performing a hierarchy-based update to the CAD model, including performing a corresponding edit to at least one other feature of the CAD model based on the edit to the first geodesic feature to produce an updated CAD model. The method includes storing the updated CAD model.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or PDM systems).

### BACKGROUND OF THE DISCLOSURE

PDM systems manage PLM and other data. Improved systems are desirable.

### SUMMARY OF THE DISCLOSURE

Various disclosed embodiments include methods for performing geodesic edits and corresponding systems and computer-readable mediums. A method includes receiving a CAD model including at least a three-dimensional (3D) surface. The method includes receiving an edit of a first geodesic feature from a user and in response to the edit, performing a hierarchy-based update to the CAD model, including performing a corresponding edit to at least one other feature of the CAD model based on the edit to the first geodesic feature to produce an updated CAD model. The method includes storing the updated CAD model.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIGS. 2A-10D illustrate geodesic features in accordance with disclosed embodiments; and

FIGS. 11 and 12 illustrate flowcharts of processes in accordance with disclosed embodiments.

### DETAILED DESCRIPTION

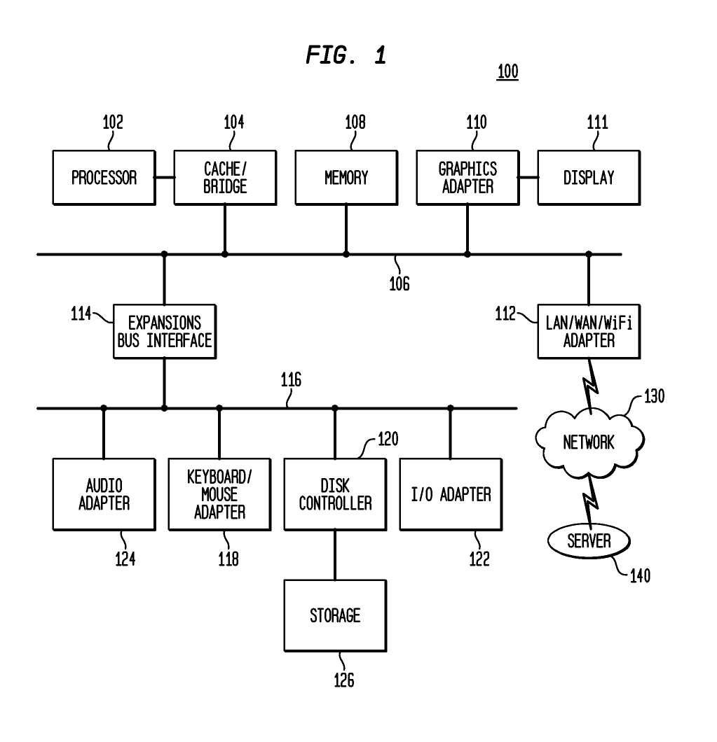

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In CAD modeling, a geodesic curve is a curve that locally minimizes the distance between two points on any mathematically defined space, such as a curved manifold. Equivalently, it is a path of minimal curvature. In noncurved three-dimensional space, the geodesic is a straight line. CAD users desired the ability to draw geodesic curves (point, line, arc, offset), modify them (trim, extend, fillet, chamfer), and the edit of their original definitions on a set of curved surfaces. Disclosed embodiments enable such processes, and support a large number of curves and maintain the original relations between them without creating as many individual features. CAD modeling using processes described herein provides fast and convenient editing of geodesic curves.

As used herein, a geodesic line follows the standard minimum distance on surface definition. Geodesic arc and circle is defined as the trajectory of a point set that has a common geodesic distance to a point on a surface. Geodesic dimension is measured by the geodesic distance. Geodesic offset is a curve offset from the base curve with a geodesic distance. Geodesic fillet is a geodesic arc that is tangent to both side curves. Geodesic chamfer is a geodesic line that connects two points on the two side curves; a center point has a common minimum geodesic distance to the two side curves at these two points (the two points would be the arc end points if it were a fillet).

Disclosed embodiments improve on techniques used for sketching on a plane or planar surface. In a traditional sketch, curves and their relations are maintained by a solver that solves all constraints concurrently. This can be done on a plane because every 2D curve and relation is very simple geometrically. On curved surfaces, a single geodesic curve creation involves iterative solving non-linear differential equations. Combining many of them to solve together is exponentially more complex thus not feasible. Disclosed embodiments include more efficient processes for geodesic curve creation and editing.

FIG. 1 illustrates a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments enable a systematic drawing of various types of recipe curves and geodesic curves in a set of connected curved surfaces in a CAD model. The system implements geodesic sketcher processes, and can support creation and edit of all the commonly used curve types, including geodesic line and arc, intersection curve, projection curve, offset curve, trim curve, fillet curve and chamfer curve. Disclosed embodiments also support creation and edit of geodesic dimension between points and curves, and can impose levels on curve types. In various embodiments, higher-level curves can reference lower-level curves, and the system can update higher level curves based on their level hierarchy if any lower level curve is edited. In particular, disclosed embodiments can process geodesic fillet and chamfer curves and geodesic dimensioning.

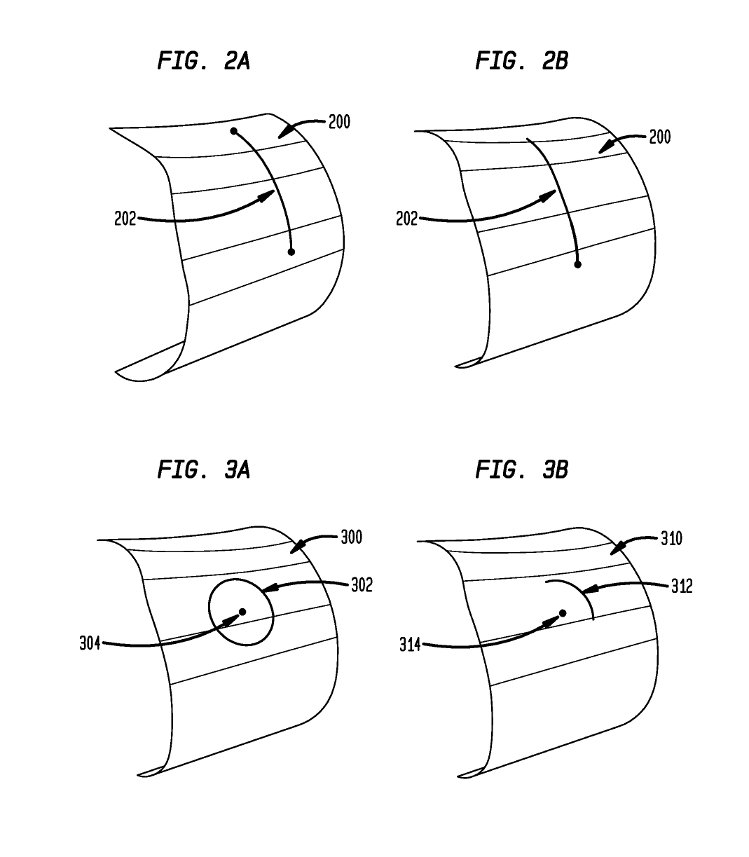

FIGS. 2A-10C illustrate geodesic features in accordance with disclosed embodiments. In each of the examples below, the illustrated CAD models are sets of connected surfaces, and the techniques described herein are used for geodesic sketching of features including those described below.

FIGS. 2A and 2B illustrate geodesic lines 202 on a CAD model 200. Geodesic line 202 follows the standard minimum distance on surface definition of CAD model 200. In FIG. 2A, geodesic line 202 follows from two points. In FIG. 2B, geodesic line 202 follows from a point and a distance along a direction.

FIGS. 3A and 3B illustrate a geodesic circle 302 on a CAD model 300 and a geodesic arc 312 on CAD model 310. Geodesic circle 302 follows the point set that has a common geodesic distance to point 304 on the surface of CAD model 300. Similarly, geodesic arc 312 follows the point set that has a common geodesic distance to point 314 on the surface of CAD model 310.

FIG. 4 illustrates a projection curve 402 on the surface of a CAD model 400. In this example, the curve network 404 is projected onto the surface of the CAD model 400, producing a corresponding geodesic projection curve network 402.

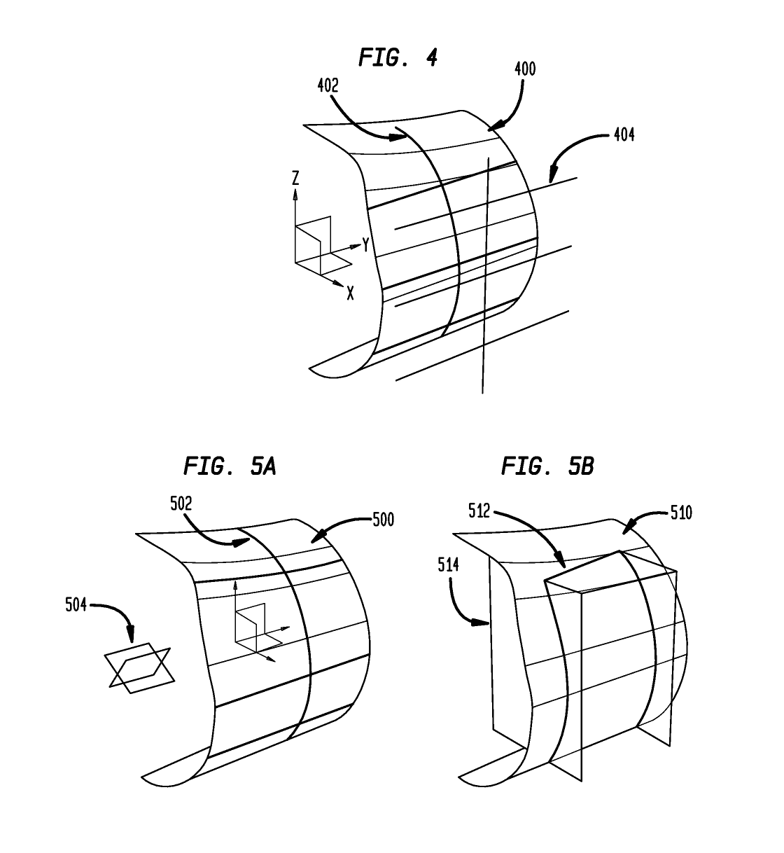

FIGS. 5A and 5B illustrate intersection curves on a CAD model. In the example of FIG. 5A, the intersection of object 504 with CAD model 500 produces geodesic intersection curve 502. In the example of FIG. 5B, the intersection of object 514 with CAD model 510 produces geodesic intersection curves 512.

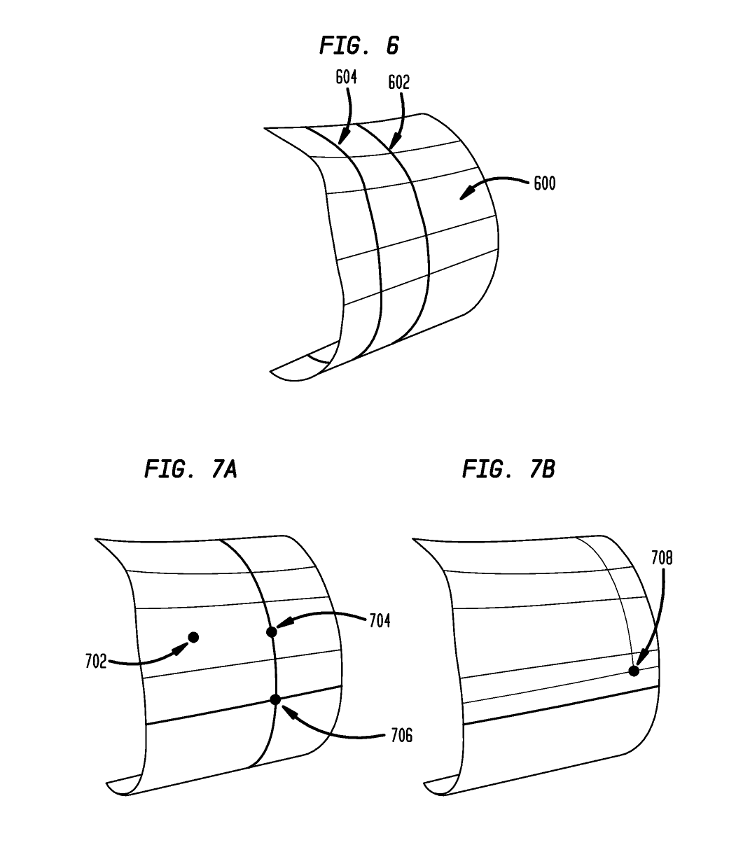

FIG. 6 illustrates a geodesic offset curve 602 on the surface of a CAD model 600. In this example, geodesic offset curve 602 is offset from curve 604 on the surface of the CAD model 600, so that the geodesic offset distance between the curves remains constant over the surface.

FIGS. 7A and 7B illustrate geodesic points on a CAD model. These points illustrate their creation “recipes”. Point 702 is a point on the surface. Point 704 is a point on a surface and on a curve. Point 706 is a point on a surface and at the intersection of two curves. Point 708 is a point on a surface and offset from a curve.

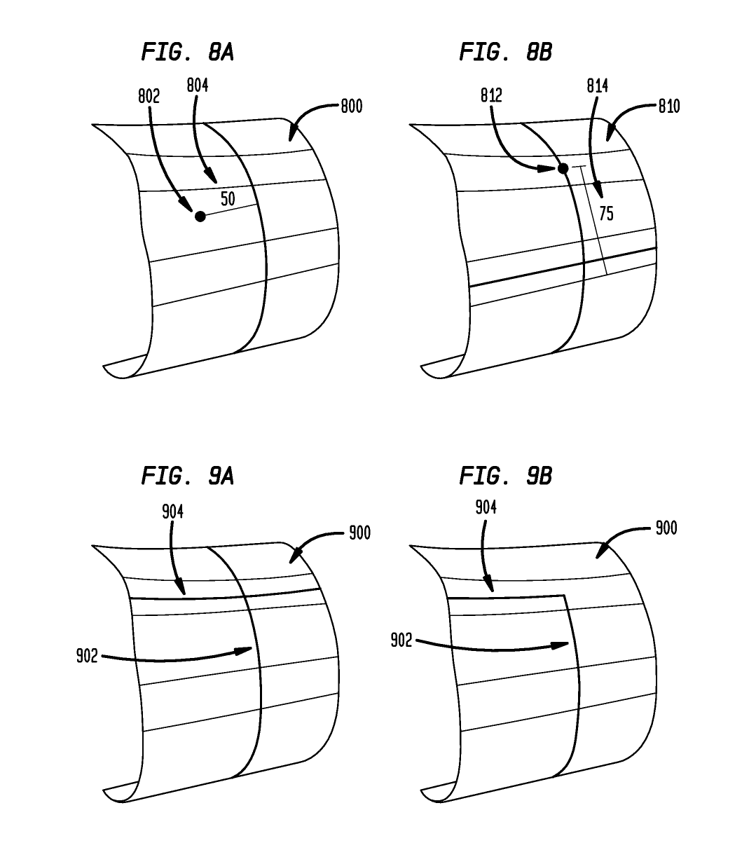

FIGS. 8A and 8B illustrate geodesic dimensions on a CAD model. In the example of FIG. 8A, point 802 on CAD model 800 is offset from the vertical line by a geodesic dimension 804. The dimension is measured by the geodesic distance between the point and the line. Similarly, in the example of FIG. 8B, point 812 on CAD model 810 is offset from the horizontal line by a geodesic dimension 814.

FIGS. 9A and 9B illustrate trimming geodesic curves on a CAD model. FIG. 9A illustrates intersecting geodesic curves 902 and 904 on the surface of CAD model 900. FIG. 9B illustrates these curves after they have been trimmed at the intersection.

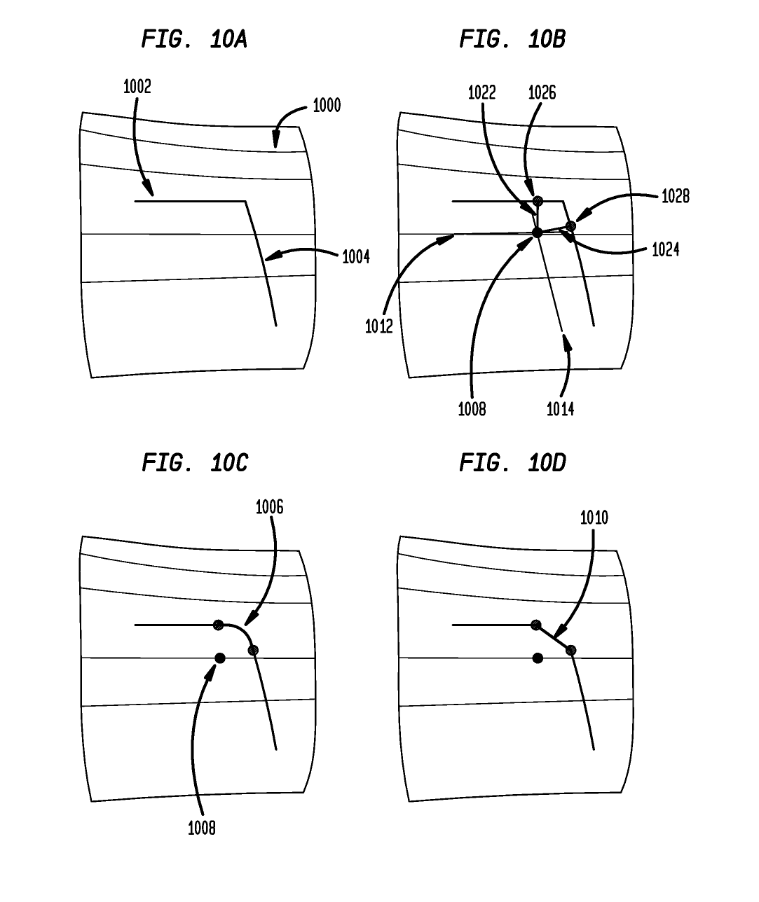

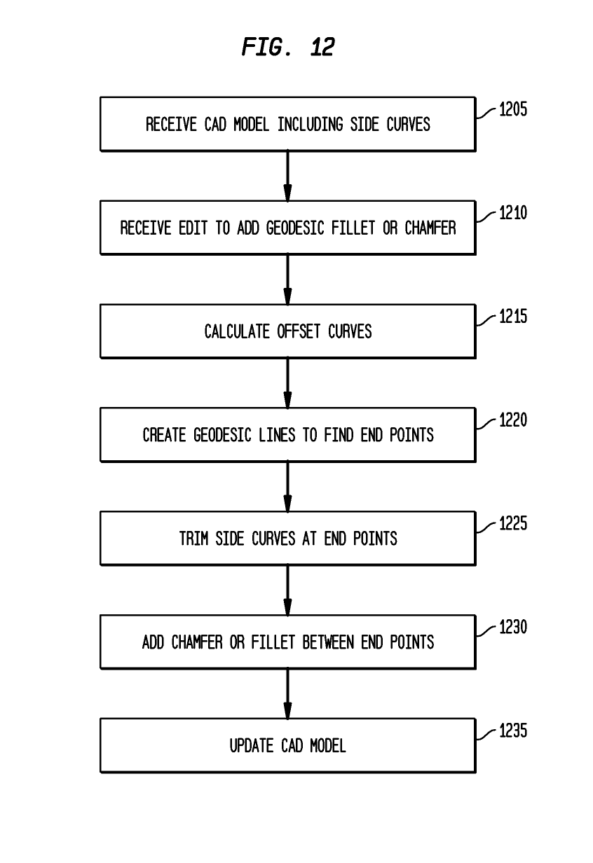

FIG. 10A-10D illustrate geodesic fillets and chamfers, as described in the flowchart of FIG. 12, below. FIG. 10A illustrates intersecting curves 1002 and 1004 on the surface of CAD model 1000.

FIG. 10B illustrates offset curves 1012 and 1014, intersection point 1008, geodesic lines 1022 and 1024, and end points 1026 and 1028.

FIG. 10C illustrates a geodesic fillet 1006 replacing the intersection, in an updated cad model 1050, where the radius of geodesic fillet 1006 follows the geodesic distance from point 1008. FIG. 10D illustrates a geodesic chamfer 1010 replacing the intersection.

Disclosed embodiments can incorporate such geodesic sketches, a hierarchy-based update, geodesic fillets and chamfers, geodesic dimensions, and other features as disclosed herein.

In various embodiments, the curve operations are associated with the original curve definitions, and the geodesic sketching process described herein allows the edit of the original definitions, to perform similarly to a feature modeling system. An advantage of the disclosed geodesic sketching processes is that they encapsulate all the dependency relations automatically, rather than leaving the burden of dealing with the long feature tree to the users. The user needs only to select the curve on the screen begin a sketching process, and after an edit, the processes disclosed herein will update the related curves locally. This is a significant advantage over other sketching processes where curves do not remember how they were created but all curves are re-solved together on an edit.

An output of various disclosed geodesic sketching processes is one single feature with many curves in the full feature model. This feature has the full associativity from upstream features in the model and the output curves can be referenced by downstream features. This also differentiates 2D-based sketching processes, where the reference plane may differ only by a transformation so all the curves can transform together rigidly upon change.

Disclosed embodiments fully interact with curved surfaces. Once the parent surface is updated, all the curves can update based on new surface geometry and their relative relations differently. Disclosed embodiments manage this complex update collectively.

Some systems use a brute force update that recreates all the curves based on their creation time stamps, which has significant performance problem. This approach is particularly unacceptable for a drawing system in which a large number of objects and operations (features) are common and a real time feedback is expected.

Disclosed embodiments address these issues using hierarchy-based update. The system first assigns an update level to each object type.

Level 0 objects refer to the static inputs, which includes the surface set (3D CAD body), and can include a primary direction and a secondary direction. These can act as inputs to the geodesic sketching process, and are the reference objects and elements that exist prior to the geodesic sketching process described below.

Level 1 objects refer to stage one curves, which are “outside in” curves. As used herein, “outside in” refers to a curve or point created by referencing objects outside the geodesic sketch, and “inside in” refers to a curve and point created by referencing objects within the sketch. For example, an “outside in” geodesic offset is an offset from a curve not belonging to the sketch (such as an edge of the surface of the sketch), while an “inside in” geodesic offset is an offset from a curve belonging to the sketch (such as a project curve). These can include intersections, projections, and geodesic offsets. Level 1 objects can also include points such as intersection points and projection points.

Level 2 objects refer to stage two curves, which are curves that reference a stage-one curve, which include “inside in” curves. These can include geodesic offsets.

Level 3 objects refer to geodesic points on faces and curves and to geodesic dimensions. These can include the geodesic distance from a point to a curve on a face, the distance along a curve from an end point, and the distance from a first point toward a second point. A dimension controls the location of a geodesic point and vice versa. The points and dimensions can solve together at the same level.

Level 4 objects refer to geodesic primitive curves, including lines, arcs, and circles. A defining point of a line or arc connects to a geodesic point.

Level 5 objects refer to geodesic corner curves, including fillets and chamfers. A geodesic corner curve references two curves in the lower levels so the corner will update after them. However, the corner curve can combine the trim operation of the next level together as a single feature object. The trim acts on the lower level curve at the end point of the corner curve.

Level 6 objects refer to geodesic curve extents, such as operations to trim or extend geodesic curves. The system can trim or extend a curve or geodesic curve to each other or to edges of surface set, or to an external datum plane. It can happen multiple times on an original curve. Each time, the system defines two new extent points representing the start and end positions of the modified curve. Only the final extent points are meaningful thus only one feature per curve is needed that will update at last.

The level hierarchy above is defined based on a general industry workflow, but can be modified based on the difference of workflows. For example, the level 2 curve may be moved to be after the level 4 geodesic primitive curve in various implementations within the scope of the disclosure.

Only higher level objects can reference lower level objects. This largely reduces the number of dependent objects that need to update when an object is changed so is much faster. An update is executed based on the order hierarchy that can be different from the time stamp order of the object creation in general. The design of the object levels makes sure the ordered update result is the same as the time-stamp creation if the inputs are the same. In particular, curve modifications (corner, extent) operate at the end of an update so that only original curves are referenced thus it does not matter in which time stamp a curve is referenced. Moreover, one copy of original geometry of each curve is kept in curve object so that curve modification can update quickly without recreating the original curve. An original curve needs to update only when its parent object changes.

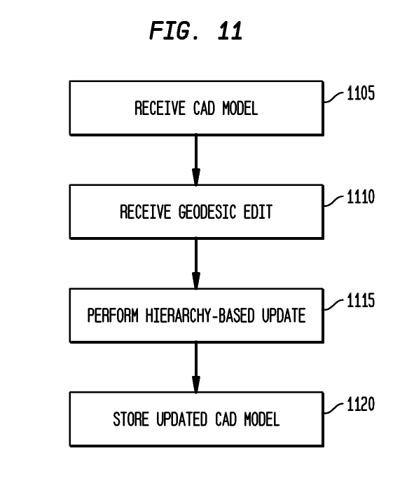

FIG. 11 depicts a flowchart of a process in accordance with disclosed embodiments that may be performed, for example, by one or more CAD systems as disclosed herein, referred to generically as the “system” below.

The system receives a CAD model including at least a three-dimensional (3D) surface (1105). The 3D surface can be comprised of sets of connected surfaces. Receiving, as used herein, can include loading from storage, receiving from another device or process, receiving via an interaction with a user, and otherwise. The 3D CAD model can include the level 0 objects described above.

The system receives an edit of a first geodesic feature from a user (1110). The edit can be the addition of a geodesic feature to the CAD model, the removal of a geodesic feature from the CAD model, a movement of a geodesic feature in the CAD model, or other change to a geodesic feature in the CAD model, such as changes to dimensions, constraints, or otherwise. When the edit is adding a geodesic fillet or chamfer, a process as described below can be used.

In response to the edit, the system performs a hierarchy-based update to the CAD model, including performing a corresponding edit to at least one other feature of the CAD model based on the edit to the first geodesic feature to produce an updated CAD model (1115). The hierarchy-based update includes successively updating other features of the CAD model, based on the edit to the first geodesic feature, from the lowest-level objects to the highest-level objects.

The system stores the updated CAD model (1120).

FIG. 12 depicts a flowchart of a process in accordance with disclosed embodiments that may be performed, for example, by one or more CAD systems as disclosed herein, referred to generically as the “system” below, to add a geodesic fillet or chamfer. The process below is illustrated in FIG. 10A-10D, described above.

The system receives a CAD model including at least a three-dimensional (3D) surface and two side curves on the 3D surface (1205). The 3D surface can be comprised of sets of connected surfaces. This step can be the same as step 1105 above, where the two side curves are present. In general, the side curves can cross each other and define the quadrant of the fillet.

The system receives an edit of a first geodesic feature from a user (1210). This step can be the same as step 1110 above, where the edit is the addition of a geodesic fillet or chamfer between the two side curves. The received edit includes a radius of the fillet or chamfer.

The system calculates offset curves, corresponding to the two side curves, along the normal directions of the side curves respectively with a geodesic distance equal to the radius and determines the intersection point of the offset curves (1215).

From the intersection point, the system creates two geodesic lines along the normal of the two offset lines respectively with a geodesic distance equal to the fillet radius back to the two side curves (1220). The two geodesic lines will then intersect the two side curves at respective end points. The two end points are the trimming positions of two side curves for the fillet or chamfer.

The system trims the two side curves at the end points (1225).

The system adds the first geodesic feature to the CAD model between the end points (1230).

When the first geodesic feature is a geodesic fillet, the system creates a geodesic arc with an intersection point as center, the two end points as limits, and the fillet radius as radius. The geodesic arc will be tangent to the two side curves. This process therefore determines the end points on the side curves without the expensive creation of the full geodesic circle and computation of its intersection with the side curves, giving a significant performance advantage.

When the first geodesic feature is a geodesic chamfer, the system creates the geodesic chamfer by adding a geodesic line between the two end points.

This system can then perform an update of the CAD model (1235), for example as described in steps 1115-1120 above.

Various embodiments can also process geodesic dimensions to allow a point to drive dimensions and vice versa on curved surfaces. Given a point and a set of connected curves on the surface of a CAD model, the system can determine the geodesic (minimum) distance from the point to the curve set and create a dimension of the distance. This dimension can then update when the point of curve changes.

In turn, the dimension can be edited to a new value that will drive the point to a new position with the new value as geodesic distance to the curve set.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. A method for performing a geodesic edit in a CAD model, the method performed by at least one data processing system and comprising:
receiving a CAD model including at least a three-dimensional (3D) surface;
receiving an edit of a first geodesic feature from a user;
in response to the edit, performing a hierarchy-based update to the CAD model, including performing a corresponding edit to at least one other feature of the CAD model based on the edit to the first geodesic feature to produce an updated CAD model; and
storing the updated CAD model.

2. The method of claim 1, wherein the hierarchical update includes making updates, in order, to stage one curves, to stage two curves that reference stage one curves, to geodesic points on faces and curves and to geodesic dimensions, to geodesic primitive curves, to geodesic corner curves, and to geodesic curve extents.

3. The method of claim 2, wherein the geodesic corner curves include at least one of a fillet and a chamfer.

4. The method of claim 2, wherein the geodesic curve extents include operations to trim or extend geodesic curves.

5. The method of claim 2, wherein the geodesic dimensions reflect the geodesic distance from a point to a curve.

6. The method of claim 1, wherein the edit of the first geodesic feature from the user is the addition of a fillet or chamfer between two side curves of the CAD model, and the system
calculates offset curves, corresponding to the two side curves, along normal directions of the side curves respectively with a geodesic distance equal to a radius and determines the intersection of the offset curves;
creates two geodesic lines, from the intersection, along a normal direction of the two offset lines respectively with a geodesic distance equal to the radius back to the two side curves to identify two end points;
trims the two side curves at the end point; and
adds the fillet or chamfer to the CAD model between the end points.

7. The method of claim 6, wherein when the first geodesic feature is a geodesic fillet, the system creates the geodesic arc with the intersection point as center, the two end points as limits, and the fillet radius as radius; and when the first geodesic feature is a geodesic chamfer, the system creates the geodesic chamfer by adding a geodesic line between the two end points.

8. A data processing system comprising:
a processor; and
an accessible memory, the data processing system particularly configured to
receive a CAD model including at least a three-dimensional (3D) surface;
receive an edit of a first geodesic feature from a user;
in response to the edit, perform a hierarchy-based update to the CAD model, including performing a corresponding edit to at least one other feature of the CAD model based on the edit to the first geodesic feature to produce an updated CAD model; and
store the updated CAD model.

9. The data processing system of claim 8, wherein the hierarchical update includes making updates, in order, to stage one curves, to stage two curves that reference stage one curves, to geodesic points on faces and curves and to geodesic dimensions, to geodesic primitive curves, to geodesic corner curves, and to geodesic curve extents.

10. The data processing system of claim 9, wherein the geodesic corner curves include at least one of a fillet and a chamfer.

11. The data processing system of claim 9, wherein the geodesic curve extents include operations to trim or extend geodesic curves.

12. The data processing system of claim 9, wherein the geodesic dimensions reflect the geodesic distance from a point to a curve.

13. The data processing system of claim 8, wherein the edit of the first geodesic feature from the user is the addition of a fillet or chamfer between two side curves of the CAD model, and the system
calculates offset curves, corresponding to the two side curves, along normal directions of the side curves respectively with a geodesic distance equal to a radius and determines the intersection of the offset curves;
creates two geodesic lines, from the intersection, along a normal direction of the two offset lines respectively with a geodesic distance equal to the radius back to the two side curves to identify two end points;
trims the two side curves at the end point; and
adds the fillet or chamfer to the CAD model between the end points.

14. The data processing system of claim 13, wherein when the first geodesic feature is a geodesic fillet, the system creates the geodesic arc with the intersection point as center, the two end points as limits, and the fillet radius as radius; and when the first geodesic feature is a geodesic chamfer, the system creates the geodesic chamfer by adding a geodesic line between the two end points.

15. A non-transitory computer-readable medium encoded with executable instructions that, when executed, cause one or more data processing systems to:
receive a CAD model including at least a three-dimensional (3D) surface;
receive an edit of a first geodesic feature from a user;
in response to the edit, perform a hierarchy-based update to the CAD model, including performing a corresponding edit to at least one other feature of the CAD model based on the edit to the first geodesic feature to produce an updated CAD model; and
store the updated CAD model.

16. The computer-readable medium of claim 15, wherein the hierarchical update includes making updates, in order, to stage one curves, to stage two curves that reference stage one curves, to geodesic points on faces and curves and to geodesic dimensions, to geodesic primitive curves, to geodesic corner curves, and to geodesic curve extents.

17. The computer-readable medium of claim 16, wherein the geodesic corner curves include at least one of a fillet and a chamfer.

18. The computer-readable medium of claim 16, wherein the geodesic curve extents include operations to trim or extend geodesic curves.

19. The computer-readable medium of claim 16, wherein the geodesic dimensions reflect the geodesic distance from a point to a curve.

20. The computer-readable medium of claim 15, wherein the edit of the first geodesic feature from the user is the addition of a fillet or chamfer between two side curves of the CAD model, and the system
calculates offset curves, corresponding to the two side curves, along normal directions of the side curves respectively with a geodesic distance equal to a radius and determines the intersection of the offset curves;
creates two geodesic lines, from the intersection, along a normal direction of the two offset lines respectively with a geodesic distance equal to the radius back to the two side curves to identify two end points;
trims the two side curves at the end point; and
adds the fillet or chamfer to the CAD model between the end points,
wherein when the first geodesic feature is a geodesic fillet, the system creates the geodesic arc with the intersection point as center, the two end points as limits, and the fillet radius as radius; and when the first geodesic feature is a geodesic chamfer, the system creates the geodesic chamfer by adding a geodesic line between the two end points.
